(19) United States
(12) Patent Application Publication
(10) Pub. No.: US 2003/0077071 A1
(43) Pub. Date: Apr. 24, 2003

(54) Fast forward trick mode and reverse trick mode using an information file

(76) Inventors: Shu Lin, Indianapolis, IN (US); Donald Henry Willis, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/121,089

(22) Filed: Apr. 11, 2002

Related U.S. Application Data
(60) Provisional application No. 60/334,914, filed on Oct. 23, 2001.

(51) Int. Cl. H04N 5/91; H04N 7/26

(52) U.S. Cl. 386/68; 386/109

(57) ABSTRACT

The invention provides a method for trick mode playback of an MPEG video presentation recorded on a storage medium (106). In response to a command requesting a trick mode playback for a portion of the MPEG video presentation, an information file (400) for the video presentation can be accessed. Information for performing the requested trick mode command can be retrieved from the information file (400). The retrieved information can include parameters identifying at least a location of an I-picture for the playback portion of the video presentation from the information file. A picture flag (565) identifying a picture as a progressive or non-progressive picture can also be retrieved from the information file. A parameter (540) in the information file (400) can also define the number of bytes contained in a GOP for the playback portion of the video presentation. The information in the information file (400) can be used to facilitate fast forward and reverse trick mode playback.

### CROSS REFERENCE TO RELATED APPLICATIONS

This is a non-provisional application of provisional application serial No. 60/334,914 filed Oct. 23, 2001.

### BACKGROUND OF THE INVENTION

1. Field of the Invention

The invention concerns improved trick mode playback, and more particularly to improvements in fast forward and reverse trick mode playback of video portion of a video presentation.

2. Description of the Related Art

The introduction of disks recorded with digitally compressed audio and video signals, for example, utilizing MPEG compression protocols, can provide sound and picture quality that is virtually indistinguishable from the original material. However, users will expect such digital video disks (DVDs) to offer, at a minimum, features similar to those of predecessor devices such as an analog video cassette recorder (VCR). For example, a DVD can be expected to provide playback in either forward or reverse directions at speeds other than a normal playback speed, designated 1×by convention. Such non-standard speed playback features are known as trick modes.

Providing trick mode features for MPEG encoded video signals can be challenging due to the hierarchical nature of the compression algorithms that are used to form pictures having varying degrees of compression into groups. These groups are termed groups of pictures (GOPs) and can require sequential decoding. A detailed description of the MPEG 2 standard is published as ISO/IEC Standard 13818-2. Notwithstanding, an MPEG 2 signal stream can comprise three types of pictures having varying degrees of content compression. An intra-coded picture (I-picture) has the least compression of the three types and can be decoded without reference to any other picture. A predictive picture (P-picture) can be compressed with reference to a preceding I-picture or P-picture and the P-picture can achieve a greater degree of compression than an I-picture. The third type of MPEG picture, termed a bi-directionally predictive picture (B-picture), can be compressed based on predictions from preceding and/or succeeding I or P pictures. B-pictures can have the greatest degree of compression. The three types of MPEG pictures can be arranged to form GOPs.

FIG. 1 depicts an exemplary GOP 55 within an MPEG display sequence 50. Referring to FIG. 1, GOP 55 can contain 12 consecutive pictures within the MPEG display sequence 50. Since only an I-picture is decodable without reference to any other picture, each GOP can only be decoded following the decoding of an I-picture. The first P-picture can be decoded and stored based on the stored preceding I-picture. The prediction of a P-picture based on the preceding I-picture is indicated by 62. Subsequent P-pictures can be predicted from the preceding P-picture. The prediction of a P-picture based on the preceding P-picture is indicated by 60 and 68. Finally, B-pictures can be decoded by means of predictions from preceding and/or succeeding reference pictures, for example, stored P-pictures. Exemplary predictions of a B-picture from a preceding P-picture are 64 and 70. Exemplary predictions of a B-picture from a succeeding P-picture are 66 and 72.

The hierarchical nature of the coded pictures comprising MPEG groups of pictures necessitate that the I-pictures and P-pictures of each GOP are decoded in the forward direction. In the forward direction, playback typically occurs sequentially although pictures can be skipped or added to achieve a desired playback speed. Importantly, in the reverse mode, features can be provided by effectively jumping back to an earlier or preceding I-picture and then decoding in a forward direction through the GOP corresponding to that I-picture. The decoded pictures can be stored in frame buffer memories for subsequent read out in a reverse direction to achieve a desired reverse program sequence.

FIG. 2 illustrates an exemplary decoding and displaying of pictures during reverse trick mode playback. Referring to FIG. 2, there is shown an MPEG display sequence 70, which contains two successive GOPs progressing in time along a time axis t. MPEG display sequence 70 depicts playback of video pictures in the forward direction occurring at a normal speed (1×) prior to time t₀. At time t₀, a reverse trick mode at three times regular speed (3×) is selected. At time to when the trick mode is initiated, I-picture I(25) can be decoded and displayed. The next picture required for decoding is I-picture I(13). To acquire I(13), a decoding transducer or read head can be repositioned from the location of I(25) to I(13) as indicated by J1. Having recovered and decoded I-picture I(13), the transducer or read head can be repositioned to acquire and decode picture P(16) as indicated by J2. This process can be repeated as indicated by J3 and J4 to acquire and decode P(19) and P(22) respectively. To ensure seamless playback, location of the prior I-picture should be timely determined and the transducer or read head should be promptly positioned to the location of the prior I-picture. It should be recognized that in the case where a file storage system such as a solid-state memory is used, then there would be an absence of a read head or transducer. In that case, the control CPU could read from a memory location of the solid-state memory.

Following the acquisition and decoding of picture P(22), the transducer or read head can be repositioned as depicted by J5 to recover picture I(1). To facilitate smooth portrayal of the video, it can be necessary to decode and display I, P, and possibly B-pictures if there are enough frame buffers available. The jump and play process can be repeated for preceding GOPs, thereby progressing haltingly backwards through the records whilst smoothly portraying the program material in a reverse sequence at a video output. With reference to FIG. 2, prior to the instant to the video pictures are sequentially played at speed 1×from I(1) through (I25). At the instant to, when the reverse trick mode at speed 3×gets selected, the pictures can be decoded in the following order—I(25), I(13), P(16), P(19), P(22), I(1), P(4), P(7), P(10). These decoded video pictures can be displayed in the following order during reverse 3×trick mode—I(25), P(22), P(19), P(16), I(13), P(10), P(7), P(4), I(1). The decoding and display of the video pictures can occur concurrently.

To provide visually smooth reproduction during trick modes, timely disk retrieval and access to specific pictures from memory can be required. Although each digital disk can be encoded with navigation data that provides picture access points, these are limited in number, and may inherently contribute to temporally aliased image motion. In order to achieve temporally smooth trick mode reproduction at varying speeds in forward and reverse directions, it can be necessary to provide access to, and decoding of all encoded pictures. This can require vast amounts of high-speed memory and where such memory is unavailable, the buffers can be overrun resulting in loss of pictures and degradation in performance. Thus, a need exists for improved trick mode performance without relying entirely on vast amounts of high-speed memory and processing power.

### SUMMARY

The invention provides a method for trick mode playback of an MPEG video presentation recorded on a storage medium. Upon receiving a command requesting a trick mode playback for a portion of the MPEG video presentation, an information file for the MPEG video presentation can be accessed. The information file can contain selected data about the MPEG video presentation, which can be used to facilitate the trick mode playback. Information for performing the requested trick mode can be retrieved from the information file. The retrieved information can include parameters identifying a location of an I-picture for the playback portion of the MPEG video presentation. A picture flag identifying a picture as a progressive or non-progressive frame can also be retrieved from the information file. A parameter in the information file can define the number of bytes contained in a GOP for the playback portion of the MPEG video presentation.

During retrieval of information from the information file, information indicating at least one of an MPEG filename, an MPEG sequence starting address, a GOP starting address, and a number of bytes in a current picture can be retrieved. The information file can be created prior to trick mode playback of the video presentation, and can be stored in a memory storage associated with a device for playback of the storage medium.

The invention also provides an apparatus for trick mode playback of an MPEG video presentation recorded on a storage medium. The apparatus can include a video processor programmed to respond to a command for trick mode playback of a portion of the MPEG video presentation. The video processor can be configured to access an information file for the MPEG video presentation. The information file can contain selected data about the MPEG video presentation for facilitating a trick mode. The video processor can retrieve from the information file, information for performing trick mode playback indicated by the command.

The apparatus can further include a processing means configured to retrieve from the information file, information identifying a location of at least one I-picture for the portion of the MPEG video presentation. The processing means can retrieve a location of at least one progressive frame flag for a portion of the MPEG video presentation from the information file. The processing means can also retrieve from the information file, a parameter indicating the number of bytes used for a GOP for a portion of the MPEG video presentation.

Other information retrieved by the processing means can include, but is not limited to, information indicating one or more of an MPEG filename, an MPEG sequence starting address, an MPEG sequence header, a GOP starting address, a number of bytes in a GOP, a picture coding type, a picture coding structure, a picture repeat flag and a number of bytes in a current picture. The information file can be created prior to the trick mode playback of the MPEG video presentation and/or it can be stored on storage medium. Notwithstanding, the information file can contain selected data for at least a portion of the MPEG video presentation for facilitating the trick mode playback.

### BRIEF DESCRIPTION OF THE FIGURES

FIG. 1 depicts an exemplary GOP structure within an MPEG display sequence.

FIG. 2 illustrates an exemplary decoding and displaying of pictures during a reverse trick mode playback.

FIG. 3 depicts a block diagram of an exemplary device 100 for implementing the trick modes in accordance with the inventive arrangements.

FIG. 4 depicts the structure of an exemplary information file in accordance with the inventive arrangements.

FIGS. 5a, 5b, 5c and 5d depicts exemplary parameters that can be included in the MPEG stream information, MPEG sequence information, GOP information and picture information.

FIGS. 6a, 6b and 6c is an exemplary flow chart illustrating a method in accordance with the inventive arrangements.

FIG. 7 illustrates determination of an offset to a previous GOP.

### DETAILED DESCRIPTION

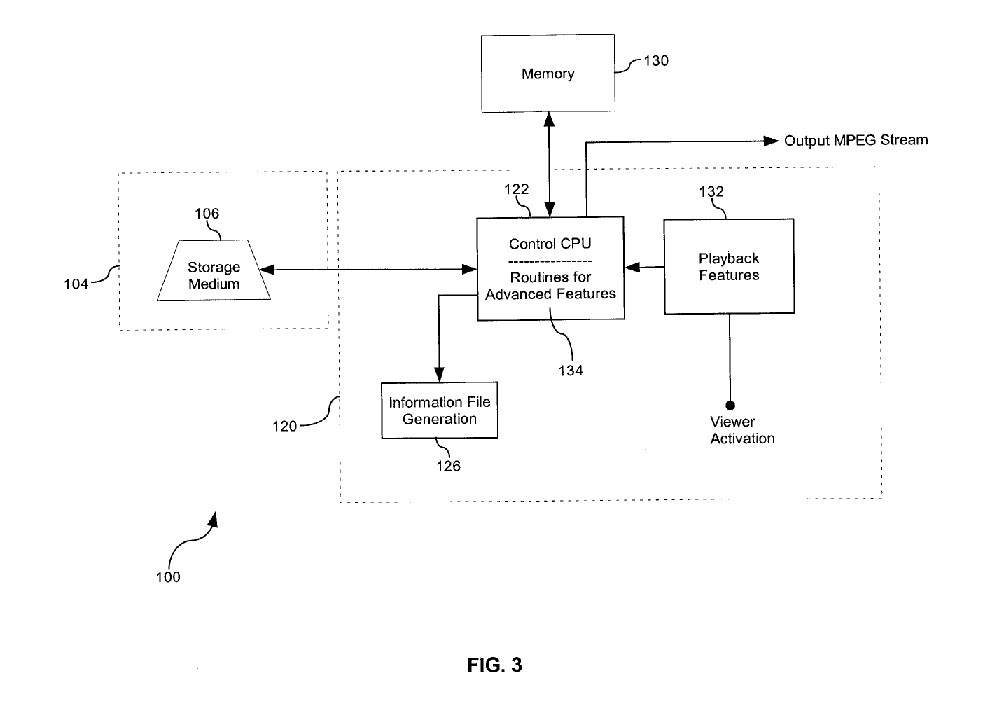

A device 100 for implementing the various advanced operating features in accordance with the invention taught herein, can utilize a file storage system 104 in accordance with the inventive arrangements depicted in the block diagram of FIG. 3. Although FIG. 3 illustrates a disk-based storage device 106, it is understood that the invention can be practiced with any MPEG or other compressed video playback device regardless of the status of the storage medium 106. As used herein, MPEG or MPEG video refers to video compression according to the MPEG encoding standard, including but not limited to MPEG-1, MPEG-2. The disc medium 106 is embodied as a fixed disk in the illustrated embodiment. In many instances, as will be appreciated the file storage system 104 can also be, for example, a solid state memory or a magneto optical disc (MOD). An example of a MOD is a mini-disc. In any case, such storage systems are well known in the art and their operation is not critical to the understanding of the instant invention.

Control section 120 of device 100 can include a control central processing unit (CPU) 122 and information file generation application and logic 126. The control CPU 122 can be configured to supply an input signal to the information file generation logic 126. The control CPU 122 can also contain routines 134 for enabling and controlling playback features in accordance with the present invention. Playback features buffer 132 for viewer activatable functions can facilitate the operation of exemplary functions, namely play, stop, reverse, fast forward, and pause. These functions, other than play and stop, are trick mode functions. The pause can be analogous to the pause operation in a VCR, which can facilitate manual interruption of the play back of a prerecorded presentation. The pause operation in a VCR could also be used for interrupting the recording of a viewed program in order to eliminate commercials from the recording.

Control CPU 122 in conjunction with the information file generation application and logic 126 can be configured to read information from storage medium 106, and/or generate and store the resulting information file. Memory 130 can be used to store the resulting information file generated by control CPU 122 and information file generation application and logic 126. The output signal generated by the control CPU 122 can be an MPEG formatted data stream. This output data can be fed to a remotely located MPEG decoder or to an NTSC or other encoder, although the invention is not limited in this regard. The use of an information file in accordance with the inventive arrangements can advantageously overcome an important limitation in decoding digitally encoded signals with a remotely located decoder. Specifically, it is very difficult to perform trick modes in remotely located decoder arrangements. Oftentimes, a trick mode involves skipping a number of pictures in a video signal such as during a fast motion trick mode. Skipping pictures in a video signal being transmitted to a remote decoder can actually increase the average bit rate of the signal. Since the bandwidth between the digital video recorder or player and the remotely located decoder is generally limited, performing a fast motion trick mode may cause the signal to exceed the maximum bit rate of the transmission channel. Advantageously, the information file can be used to predict the occurrence of certain events and to solve problems such as excessive bit rate, by dispersing dummy pictures throughout the MPEG video stream to provide a smoother trick mode.

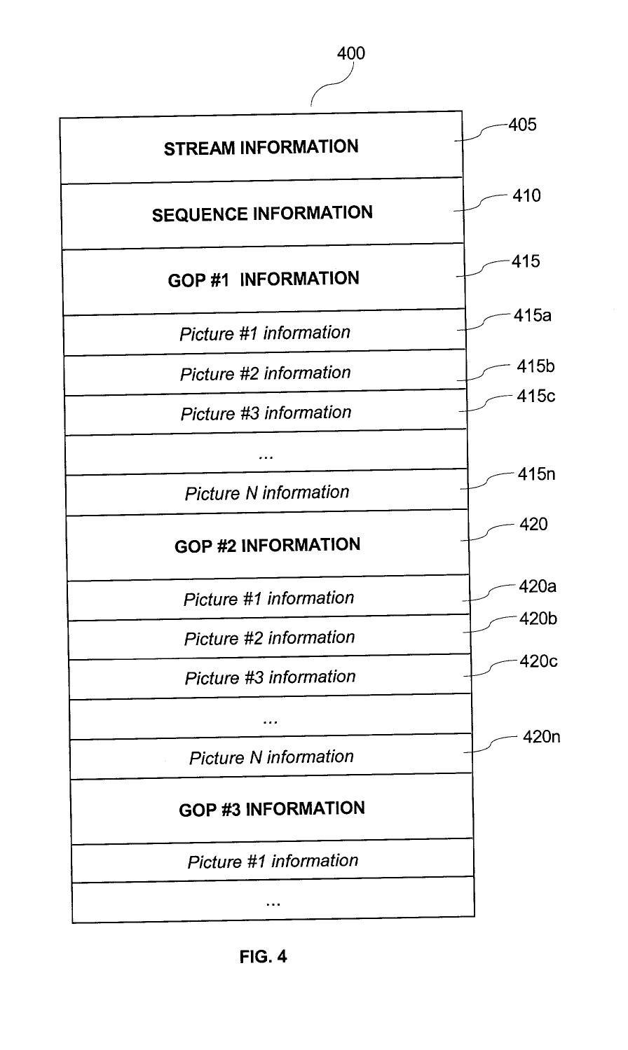

Turning now to the inventive arrangements, FIG. 4 depicts the structure of an exemplary information file 400. Referring to FIG. 4, MPEG stream information 405, MPEG sequence information 410, GOP information 415, 420 and picture information 415a, 415b, 415c, 415n, 420a, 420b, 420c, 420n can be included in the information file 400. Parameters contained in the MPEG stream information 405, MPEG sequence information 410, GOP information 415, 420 and picture information 415a, 415b, 415c, 415n, 420a, 420b, 420c, 420n can be used to describe the characteristics of an MPEG data stream representing an MPEG video presentation. The information file 400 can be represented as a data structure and stored in memory 130 and/or in a media, where each parameter can be readily accessed. To permit fast access to the parameters in the information file 400, the information file can be read and stored in a random access memory (RAM). Alternatively, the information file can be generated at the initial stage of playing an MPEG video presentation. In that case, the information file can be created and stored directly to RAM. The information file can also be generated during playback an MPEG video presentation. This can be particularly useful during reverse trick modes.

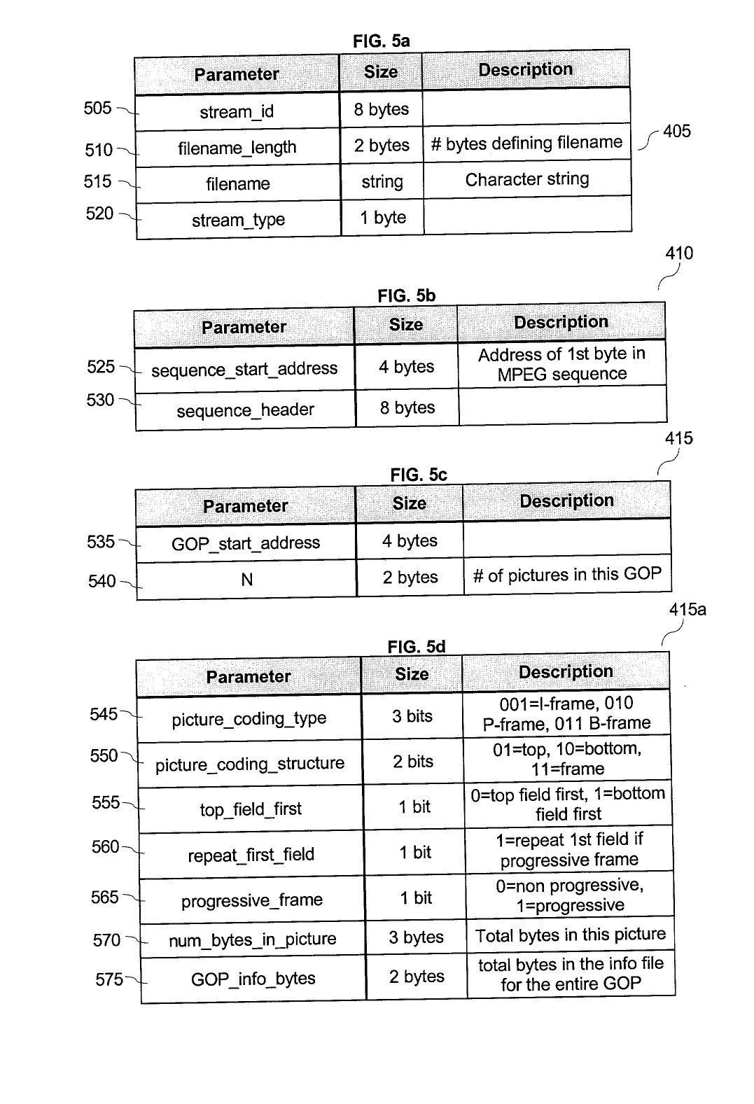

The MPEG stream information 405 can function as a file header, which can include parameters defining an MPEG data stream for the MPEG video presentation. FIG. 5a depicts exemplary parameters that can be included in the MPEG stream information 405. Referring to FIG. 5a, there are shown several parameters that include an MPEG data stream identifier (stream_id) 505, a length of the MPEG filename (filename_length) 510, a filename identifier (filename) 515, and an MPEG stream type identifier (stream_type) 520. The stream_id 505 can be used to uniquely identify an MPEG video presentation. The filename_length 510 defines the number of bytes occupied by the filename identifier 515. The filename 515 can be a character string representing the name of the file containing the MPEG data stream. Finally, the stream_type 520 can identify the type of MPEG data stream comprising an MPEG video presentation.

FIG. 5b depicts exemplary parameters that can be used to define the MPEG sequence information 410. Referring to FIG. 5b, the MPEG sequence information 410 can include a starting address (sequence_start_address) 525 for a particular MPEG display sequence contained within an MPEG data stream and a sequence header (sequence_header) 530. An MPEG display sequence is a subset of an MPEG data stream for the MPEG video presentation. The sequence_start_address 525 can define the physical location or sector of a storage device where the first byte in the MPEG display sequence is located. The MPEG sequence information 410 can appear once for each MPEG display sequence in an MPEG video presentation. The sequence_header 530 can define the characteristics of a particular MPEG sequence.

FIG. 5c depicts exemplary parameters that can be used to define the GOP information 415. Referring to FIG. 5c, the GOP information 415 can include the starting address of the GOP (GOP_start_address) 535 and the number of pictures in the GOP N 540. The GOP_start_address 535 represents the physical location of the first I-picture in a GOP. The GOP_start_address 535 can be represented as an offset from the sequence_start_address 525 and refers to the physical location or sector of the storage media.

FIG. 5d depicts exemplary parameters that can be used to define the picture information, for example 415a. Referring to FIG. 5d, the picture information can include parameters that can define the characteristics of the pictures in a GOP. The picture information 415a can include parameters defining the picture coding type (picture_coding_type) 545, picture coding structure (picture_coding_structure) 550 and picture scan type (progressive_frame) 565. The picture_coding_type can use bits to represent the coding type. For example, binary 1 (001) can represent an I-picture, binary 2 (010) can represent a P-picture and binary 3 (011) can represent a B-picture.

Parameters in the picture information can further describe how a picture should be displayed. For example, a top_field_first parameter 555 can define whether top field for a picture should be displayed first or whether a bottom field for a picture should be displayed first for a frame picture which has two fields. A one (1) can represent top field should be displayed first and a zero (0) can represent a bottom field should be displayed first. A repeat_first field parameter 560 can define whether the first field or the picture should be repeated if the picture is a progressive frame. Finally, the number of bytes of data in the picture (num_bytes in_picture) 570 can be defined. For reverse trick modes, a GOP_info_bytes parameter 575 can define the total number of information bytes in the information file for the GOP, which can be used to determine the starting address of the prior GOP information. Importantly, it should be noted that GOP_info_bytes 575 is not found in the information for every picture within the information file, but is only located within the last picture information for a GOP in the information file. Particularly, the GOP_info_bytes 575 is the last 2 bytes of the last picture within a GOP in the information file 400.

It should be recognized that although FIGS. 5a, 5b, 5c and 5d defines the size of each parameter in the exemplary information file as bit or bytes, the invention is not limited in this regard. Accordingly, the sizes of each parameter can vary depending on a particular application. Furthermore, the parameters are exemplary and in no way intended to limit the scope of the invention.

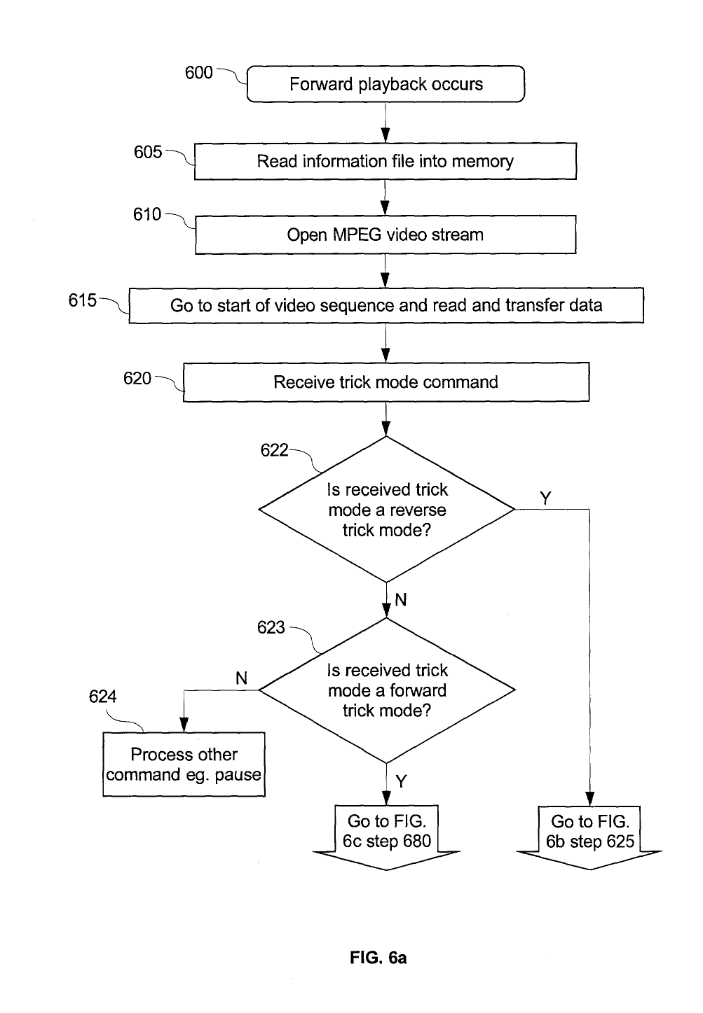

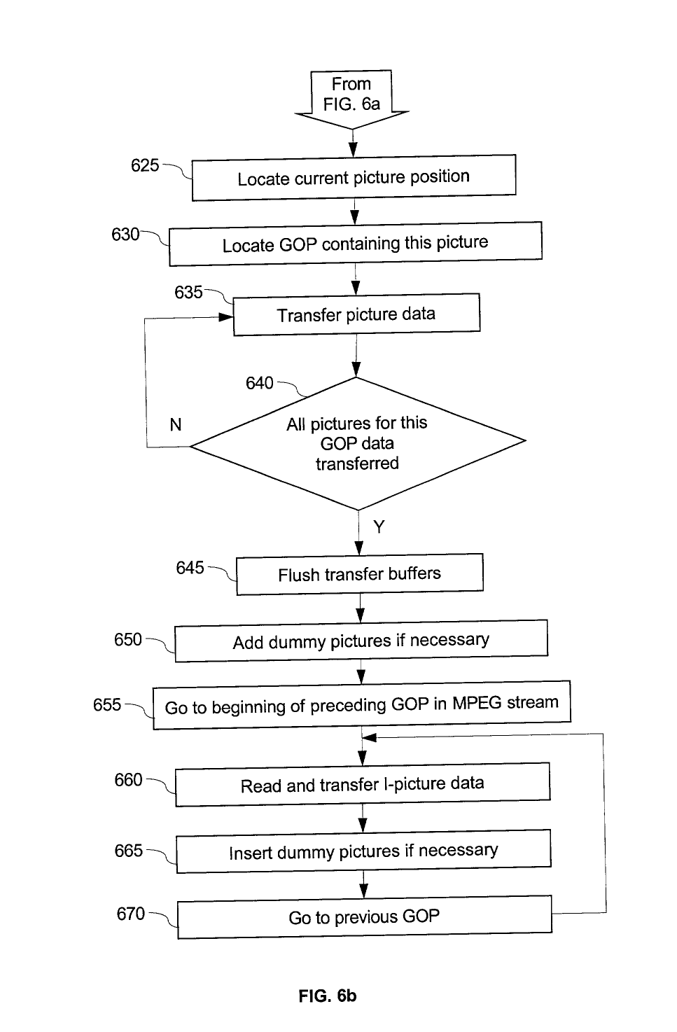

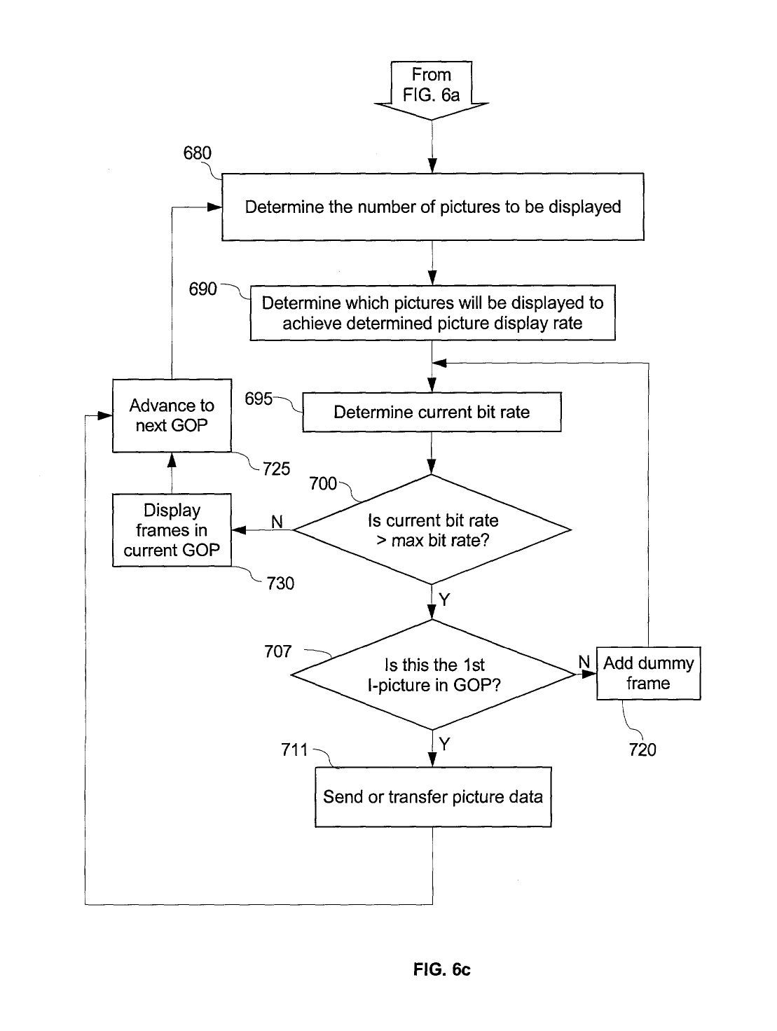

FIGS. 6a, 6b and 6c in combination is a flow chart describing exemplary steps for utilizing an information file during a trick mode. An information file can be used for forward and reverse trick modes. Referring to FIG. 6a, normal playback at 1×speed in the forward direction occurs during step 600. During this forward playback, the information file can be read into RAM instep 605. In step 610, the MPEG video stream can be opened. It should be recognized that it is not necessary for the playback to occur in the forward direction in order to execute a video trick mode. Importantly, based on information read from the information file 400, a read head of hard disk 106 can be advanced directly to a specified location on a disk where a particular MPEG video sequence is located and a trick mode such as a reverse or forward trick mode, started from that specified location.

Subsequent to opening the MPEG video stream in step 610, in step 615 a read head of hard disk 106 can be repositioned to begin reading and transferring data starting from the beginning of an MPEG data sequence. A trick mode command can be received in step 620. In step 622, a determination can be made whether the received trick mode is a reverse trick mode. If the received trick mode is a reverse trick mode then step 625 in FIG. 6b can be executed. If the received trick mode is not a reverse trick mode then a determination is made whether the received trick mode is a forward trick mode in step 623. If the received trick mode is a forward trick mode, then step 680 in FIG. 6c can be executed. If the received trick mode is not a forward trick mode, then processing of another trick mode, for example pause, can occur in step 624.

Referring to FIG. 6b, subsequent to determining that a reverse trick mode command has been received in step 622, the current picture position can be located in step 625. The current picture position on the hard disk 106 can be determined based on its physical location or sector on the media. In step 630, the GOP containing the current picture can subsequently be located based on the information file 400. For example, the GOP containing the current picture position can be determined by comparing the physical location of picture position to the GOP_start_address 535 in the information file 400. Since pictures are constantly being decoded and displayed, the pictures for the current GOP can be transferred in step 635. In step 640, a determination is made whether the current picture has been transferred. If the current picture has not been transferred, then step 635 can be executed to ensure that all the data in the current picture has been transferred from the transfer buffer. When the current picture has been transferred, and in preparation for transferring pictures for the reverse trick mode, the transfer buffer should be flushed in step 645. Due to latency occurring while a read head of hard disk 106 is being relocated, dummy pictures can be added to ensure continuity of the MPEG video presentation display. Hence, in step 650, dummy pictures can be added where necessary to ensure continuity. The addition of dummy pictures can include the addition of P-pictures and/or B-pictures, which can be predicted from the last I-picture or P-picture that was transferred.

In step 655, a read head of hard disk 106 can be repositioned at the beginning of the preceding GOP in the MPEG stream. This can be done by extracting the GOP_start_address 535 from the GOP information 415. In particular, the GOP_start_address 535 can be determined from the GOP information 415. In step 660, data can be read from this location, which is an I-picture location. In step 665, dummy picture pictures can be inserted where necessary to maintain a desired reverse playback speed. The dummy pictures can be P-pictures and/or B-pictures, which can be predicted from a previous reference picture. In step 670, the starting address of the previous GOP can be determined and the read head of hard disk 106 can be repositioned at the determined location, which is the start of the previous GOP. A starting address for the previous GOP can be determined based on various parameters located in the information file 400. Steps 660 and 665 can subsequently be repeated after step 670 until the reverse trick mode is cancelled or the beginning of the MPEG data is reached.

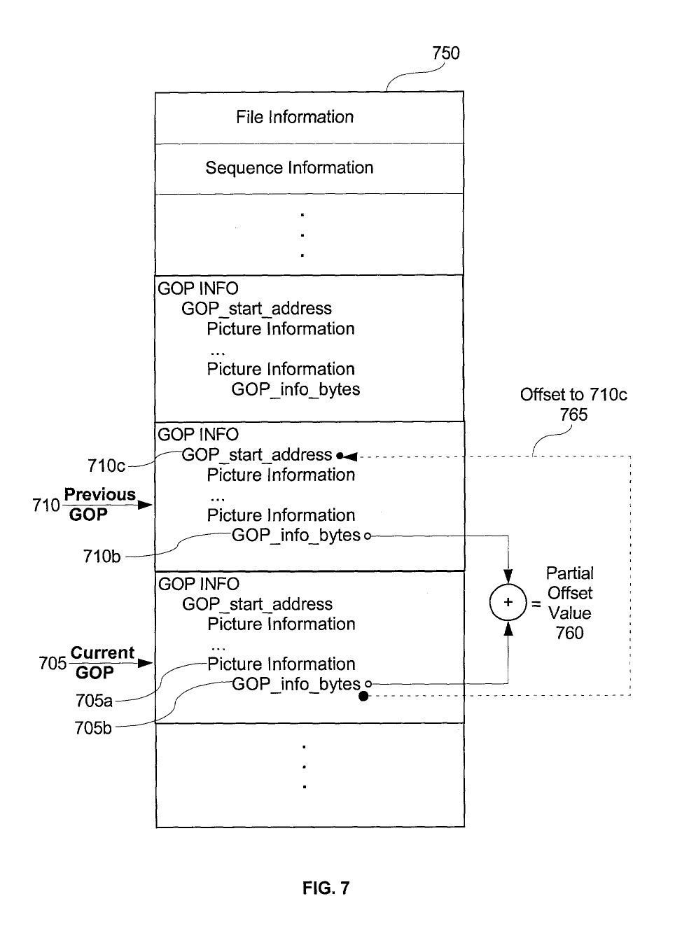

FIG. 7 illustrates exemplary steps for determining the offset in the information file to a previous GOP information. Referring to FIG. 7, there is shown an information file 750, having information for a current GOP 705 and a previous GOP 710. The total bytes in the information file 400 for the entire current GOP 705 can be represented by a GOP_info_bytes parameter 705b and the total bytes in the information file 400 for the entire previous GOP 710 can be represented by a GOP_info_bytes parameter 710b. The last picture in the current GOP 705 can be represented by parameter 705a. Notably, a partial offset value 760 within the information file 400 which represents the offset from the end of the current GOP 705 to the beginning of the previous GOP 710 can be determined by adding the address values corresponding to 705b and 710b, namely, (705b+710b). Importantly, an actual offset 765 within the information file 400, can be defined to start at the end of the current GOP 705 information and end at the beginning of the previous GOP 710 information. The actual offset 765 to the previous GOP_start_address 710c is shown and is equivalent to the partial offset value 760. This actual offset 765 can be stored in memory 130 and can be used for the next jump back. The read head of hard disk 106 can be relocated from the physical location of the last picture identified by parameter 705a in the current GOP 705 to the physical location identified by the starting address identified by GOP_start_address 710c of the previous GOP 710. Notwithstanding, it should readily be understood that the partial offset value 760 is used for illustrative purposes and is not intended to limit the invention. Furthermore, the determination of a partial offset value 760 is not necessary to the practice of the invention.

Referring to FIG. 6c, subsequent to determining that a forward trick mode command has been received in step 623, the number of pictures to be displayed can be determined in step 680. The forward trick mode can be a low fast forward trick mode in which playback speed can typically range between 2×and 8×. During the low fast forward trick mode, I-pictures and P-pictures can be displayed to achieve a desired playback rate. The forward trick mode can also be a medium fast forward trick mode in which playback speed can typically range between 5×and 15×.

During the medium fast forward trick mode, I-pictures can be displayed and GOPs are preferably not skipped in order to achieve a desired playback rate. Additionally, the forward trick mode can also be an ultra fast forward trick mode in which speeds are in excess of 15×. During the ultra fast forward trick mode, it can be preferable to display only I-pictures in order to achieve a desired playback rate.

In step 690, a determination is made as to which pictures will be displayed to achieve the determined picture display rate. In step 695, the current bit rate can be determined. In decision block 700, a determination is made whether the current bit rate exceeds the maximum bit rate that is permitted without causing a buffer overrun condition. If the maximum bit rate has not been exceeded, then the pictures for the current GOP can be displayed in step 730. Subsequent to displaying the pictures in the current GOP, a read head of hard disk 106 can be advanced to the physical location of the identified by the starting address of the next GOP in step 725. The starting address of the first I-picture in the next GOP can be determined from the GOP_start_address 535 parameter in the GOP information 415 of the information file 400.

Returning to decision block 700, if the current bit rate exceeds the maximum bit rate, then in step 707, a determination can be made whether the current picture in the GOP is an anchor or I-picture. If the current picture is an I-picture, then the picture data is transferred in step 711. The read head of hard disk 106 can subsequently advance to the location identified by the starting address of the next GOP in step 725. Again, the location of the first I-picture in the next GOP can be determined from the GOP_start_address 535 parameter in the GOP information 415 of the information file 400.

Returning to step 707, if the current picture is not the first I-picture or anchor picture in the GOP, then a dummy picture can be added in step 720. The bit rate can subsequently be checked in step 695, and decision block 700 accordingly executed.

It should be recognized that separate forward information file and reverse information file can be maintained for fast forward trick mode and reverse trick mode respectively. Notwithstanding, a single information file containing parameters for both forward trick modes and reverse trick modes can be maintained and would be preferable. In a case where separate information files are maintained, it should be recognized that the forward information file does not require the GOP parameter GOP_info_bytes 575, since in forward trick mode, there in no need to calculate an offset to the previous GOP.

In light of the foregoing description of the invention, it should be recognized that the present invention can be realized in hardware, software, or a combination of hardware and software. Fast forward trick mode and reverse trick mode using an information file according to the present invention can be realized in a centralized fashion, or in a distributed fashion where different video processing elements are spread across several interconnected systems. Advantageously, in such an entertainment system, the information file can be used to communicate information between independently and remotely located MPEG decoders. Any kind of computerized or digital MPEG processing system, or other apparatus adapted for carrying out the methods described herein, is suited.

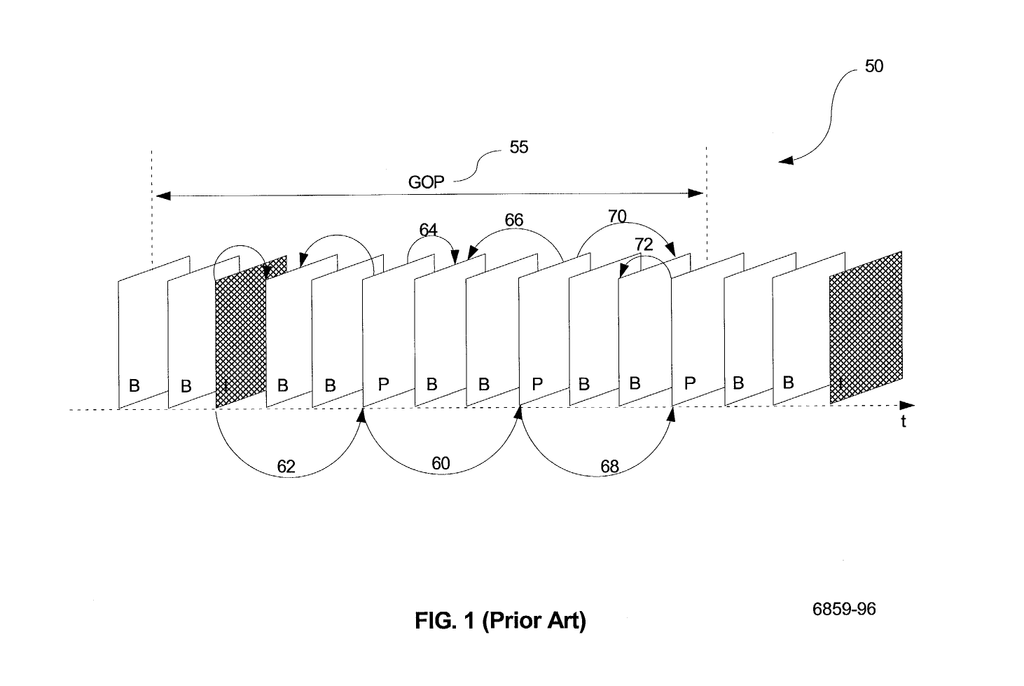

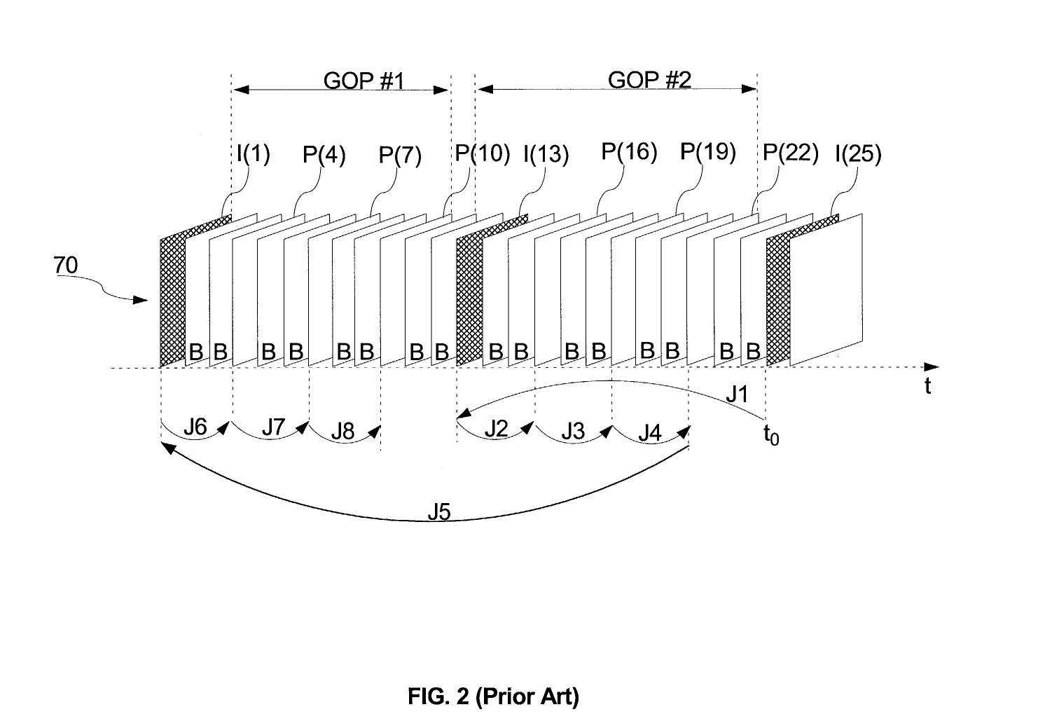

Although the present invention as described herein contemplates the control CPU 122 of FIG. 1, a typical combination of hardware and software can further include a general purpose computer system with a computer program that, when being loaded and executed, controls the computer system and a digital video recording system similar to the control section 120 of FIG. 1, such that it carries out the methods described herein. The present invention can also be embedded in a computer program product which comprises all the features enabling the implementation of the methods described herein, and which when loaded in a computer system is able to carry our these methods.

A computer program in the present context means any expression, in any language, code or notation, of a set of instructions intended to cause a system having an information processing capability to perform a particular function either directly or after either or both of the following a) conversion to another language, code or notation; b) reproduction in a different material form.

The description above is intended by way of example only and is not intended to limit the present invention in any way, except as set forth in the following claims.

What is claimed is:

1. A method for trick mode playback of an MPEG video presentation recorded on a storage medium, comprising:
responsive to a command for trick mode playback of a portion of the MPEG video presentation, accessing an information file for the MPEG video presentation, said information file containing selected data about the MPEG video presentation for facilitating said trick mode;
retrieving from said information file, information for performing said trick mode playback indicated by said command.

2. The method according to claim 1, wherein said retrieving step comprises retrieving from said information file information identifying a location of at least one I picture for said portion of the MPEG video presentation.

3. The method according to claim 1, wherein said retrieving step comprises retrieving from said information file a location of at least one progressive frame flag for said portion of the MPEG video presentation.

4. The method according to claim 1, wherein said retrieving step comprises retrieving from said information file information indicating the number of bytes used for a GOP for said portion of the MPEG video presentation.

5. The method according to claim 1, wherein said retrieving step comprises retrieving from said information file information indicating at least one of an MPEG filename, an MPEG sequence starting address, an MPEG sequence header, a GOP starting address, a number of bytes in a GOP, a picture coding type, a picture coding structure, a picture repeat flag and a number of bytes in a current picture.

6. The method according to claim 1, further comprising creating said information file prior to said trick mode playback of said MPEG video presentation.

7. The method according to claim 6, further comprising storing said information file on said storage medium.

8. The method according to claim 6, further comprising storing said information file in a memory storage associated with a device for playback of said storage medium.

9. The method according to claim 1, wherein said information file contains selected data for at least a portion of the MPEG video presentation for facilitating the trick mode playback.

10. An apparatus for trick mode playback of an MPEG video presentation recorded on a storage medium, comprising:
a video processor programmed to respond to a command for trick mode playback of a portion of the MPEG video presentation, said video processor configured to:
access an information file for the MPEG video presentation, said information file containing selected data about the MPEG video presentation for facilitating said trick mode; and
retrieve from said information file, information for performing said trick mode playback indicated by said command.

11. The apparatus according to claim 10, further comprising processing means configured to retrieve from said information file, information identifying a location of at least one I-picture for said portion of the MPEG video presentation.

12. The apparatus according to claim 10, wherein said processing means retrieves from said information file a location of at least one progressive frame flag for said portion of the MPEG video presentation.

13. The apparatus according to claim 10, wherein said processing means retrieves from said information file information indicating the number of bytes used for a GOP for said portion of the MPEG video presentation.

14. The apparatus according to claim 10, wherein said processing means retrieves from said information file, information indicating at least one of an MPEG filename, an MPEG sequence starting address, an MPEG sequence header, a GOP starting address, a number of bytes in a GOP, a picture coding type, a picture coding structure, a picture repeat flag and a number of bytes in a current picture.

15. The apparatus according to claim 10, wherein said processing means creates said information file prior to said trick mode playback of said MPEG video presentation.

16. The apparatus according to claim 15, wherein said processing means stores said information file on said storage medium.

17. The apparatus according to claim 15, wherein said processing means stores said information file in a memory storage associated with a device for playback of said storage medium.

18. The apparatus according to claim 10, wherein said information file contains selected data for at least a portion of the MPEG video presentation for facilitating the trick mode playback.
